(19) United States
(12) Patent Application Publication
(10) Pub. No.: US 2012/0195709 A1
(43) Pub. Date: Aug. 2, 2012

(54) CONNECTION ASSEMBLY AND METHOD FOR REMOVABLE FASTENING AN ATTACHMENT PART TO A CARRIER

(76) Inventor: Michael Demerath, Hueffler (DE)

(21) Appl. No.: 13/394,846

(22) PCT Filed: Oct. 5, 2010
(86) PCT No.: PCT/EP2010/006077

§ 371 Date: Apr. 9, 2012

(30) Foreign Application Priority Data
Oct. 7, 2009 (DE) 10 2009 048 441.8

(51) Int. Cl. F16B 19/10

(52) U.S. Cl. 411/80.1

(57) ABSTRACT

The invention relates to a connecting assembly (10) and a method for releasably attaching a mount-on part (12) to a carrier (14), having a receiving element (16) which includes at least one elastically deformable latching element (18) that protrudes inwards, and a holding pin (20) which includes a shank (22) that is insertable into the receiving element (16) in the direction of a longitudinal axis (A), the shank (22) having an external thread (24) formed thereon which in a locking condition of the connecting assembly (10) establishes a form-fitting connection with the latching element (18). The connecting assembly (10) has a production state, in which the receiving element (16) and the holding pin (20) are connected with each other in one piece. Preferably, one of the holding pin (20) and the receiving element (16) includes a spring section (48) which in the locking condition acts axially upon the holding pin (20) in relation to the receiving element (16) to ensure a defined latching engagement between the external thread (24) and the latching element (18).

### RELATED APPLICATIONS

This application corresponds to PCT/EP2010/006077, filed Oct. 5, 2010, which claims the benefit of German Application No. 10 2009 048 441.8, filed Oct. 7, 2009, the subject matter, of which are incorporated herein by reference in their entirety.

### BACKGROUND OF THE INVENTION

The present invention relates to a connecting assembly and a method for releasably attaching a mount-on part to a carrier, having a receiving element which includes at least one elastically deformable latching element that protrudes inwards, and a holding pin which includes a shank that is insertable into the receiving element in the direction of a longitudinal axis.

Connecting assemblies of this type are used in particular in the automotive industry, for example for the attachment of inner lining parts to body parts of a motor vehicle.

DE 20 2008 010 262 U1 already discloses such a connecting assembly; in this publication, special importance was attached to a reversible, i.e. releasable, attachment of the mount-on part to the carrier.

Further, EP 1 260 719 A1 also shows a releasable and reusable connecting assembly in which the latching element of the receiving element can engage with a threaded section formed on the shank.

### SUMMARY OF THE INVENTION

The object of the present invention is to provide a connecting assembly for reversibly/releasably attaching a mount-on part to a carrier and which, for one thing, is particularly simple and cost-effective to produce and, for another thing, snaps into place particularly reliably in a locking condition.

This object is achieved according to the invention by a connecting assembly for releasably attaching a mount-on part to a carrier, having a receiving element which includes at least one elastically deformable latching element that protrudes inwards, and a holding pin which includes a shank that is insertable into the receiving element in the direction of a longitudinal axis, the shank having an external thread formed thereon which in a locking condition of the connecting assembly establishes a form-fitting connection with the latching element, and the connecting assembly having a production state in which the receiving element and the holding pin are connected with each other in one piece. The thread grooves in the shank offer numerous possibilities for the latching element to engage and produce a form fit, which are in close succession in the axial direction as spaced by the thread pitch or lead. This results in a reliable latching connection between the receiving element and the holding pin in the locking condition of the connecting assembly. Furthermore, the connecting assembly is especially simple and cost-effective to manufacture since the holding pin and the receiving element are connected with each other in one piece in a production state. The production state is the initial state of the connecting assembly immediately after its production.

In a particularly low-cost embodiment of the connecting assembly, the receiving element and the holding pin are produced as a one-piece injection molded part from a plastic material.

In the production state of the connecting assembly, a predetermined breaking point is preferably provided between the receiving element and the holding pin. For one thing, the predetermined breaking point reduces an axial actuating force necessary for transferring the connecting assembly from the production state to a preassembly condition or locking condition since the holding pin and the receiving element can be easily separated from each other. For another thing, this predetermined breaking point provides for a clearly defined dividing line between the receiving element and the holding pin, as a result of which in the region of the dividing point an undefined tearing of the material is prevented.

The object set forth above is furthermore also achieved by a connecting assembly for releasably attaching a mount-on part to a carrier, having a receiving element which includes at least one elastically deformable latching element that protrudes inwards, and a holding pin which includes a shank that is insertable into the receiving element in the direction of a longitudinal axis, the shank having an external thread formed thereon which in the locking condition of the connecting assembly establishes a form-fitting connection with the latching element, and one of the holding pin and the receiving element including a spring section which in the locking condition acts axially upon the holding pin in relation to the receiving element to ensure a defined latching engagement between the external thread and the latching element. This spring section ensures a particularly secure and reliable latching connection between the holding pin and the receiving element in the locking condition of the connecting assembly. When the holding pin is pushed axially into the receiving element, it might happen that the elastically deformable latching element, in a presumed locking condition, does not engage in a thread groove, but rests against the spiral thread projection between two thread grooves, in a condition expanded radially outwards. In such a case, the deformable latching element may, over time, lose its radially inwardly directed elastic tension force, for example by relaxation. As a consequence, the deformable latching element will not snap radially inwards into the next thread groove any more, even when there is an axial relative movement of the shank. The holding pin can thus no longer be unscrewed from the receiving element, as a result of which it is no longer possible or at least considerably more difficult to release the attachment between the mount-on part and the carrier. To prevent this, the spring section generates an advantageous axial force between the receiving element and the holding pin in the locking condition of the connecting assembly. This axial force is preferably selected such that it is smaller than an axial holding force when there is a defined latching engagement of the latching element with a thread groove of the external thread. But the axial force of the spring section is sufficient to shift the holding pin from a presumed locking condition of the connecting assembly, in which the latching element rests against the spiral thread projection between two thread grooves, relative to the receiving element to such an extent until the latching element snaps into the next thread groove.

In one embodiment of the connecting assembly, the holding pin comprises the shank that is insertable into the receiving element, and a head, the head being at least partially formed as spring section. In this case, the spring section may be directly integrated into the holding pin with little effort.

In the production state of the connecting assembly, the holding pin and the receiving element assume an axial relative position in relation to each other that is different from that in the locking condition of the connecting assembly, the connecting assembly preferably having a preassembly condition in which the holding pin and the receiving element assume an axial relative position in relation to each other which is between the axial relative position in the production state and the axial relative position in the locking condition. Proceeding from the production state, the connecting assembly can assume a preassembly condition and a locking condition by an axial relative movement between the holding pin and the receiving element, the connecting assembly being adapted to be transferred from the preassembly condition to the locking condition by pressing the holding pin axially into the receiving element and back to the preassembly condition by rotating the holding pin relative to the receiving element about the longitudinal axis. In this variant of the embodiment, the mount-on part can be attached to the carrier very rapidly and without a tool. In addition, this attachment can also be released again with little effort, without the connecting assembly being destroyed in the process or its connecting force being impaired when it is again used as a fastening means.

In a further embodiment of the connecting assembly, the receiving element is insertable both into an opening of the mount-on part and into an opening of the carrier, and further includes holding means for securing the receiving element in place on the carrier.

Preferably, these holding means are elastic feet that are deflectable radially outwards by the axial displacement of the holding pin. The manufacture of clamping feet on the receiving element, which may be radially spread apart, is, for one thing, possible with little effort and, for another thing, offers a simple and reliable way of attaching the receiving element to the carrier.

In a further embodiment, the receiving element has an anti-rotation protection means which, in the locking condition of the connecting assembly, prevents the receiving element from rotating about the longitudinal axis relative to the mount-on part and/or the carrier. This way of fixing the receiving element in place so as to be non-rotatable in the locking condition allows the connecting assembly to be transferred to its preassembly condition particularly simply. To this end, the holding pin may be simply unscrewed from the non-rotatably held receiving element manually or using a suitable tool, until a preassembly condition of the connecting assembly is reached.

To attain an especially rapid transfer of the connecting assembly from its locking condition to its preassembly condition, the external thread preferably is a multiple thread. Accordingly, the connecting assembly can be moved from its locking condition to its preassembly condition by few turns of the holding pin in relation to the receiving element.

Finally, the object set forth above is also achieved by a method for releasably attaching a mount-on part to a carrier by means of a connecting assembly as described above which has a production state, a preassembly condition, in which the connecting assembly can be released from the mount-on part and from the carrier, and a locking condition, in which the connecting assembly, the mount-on part and the carrier are attached to each other, the connecting assembly being urged by a spring section from the locking condition towards the preassembly condition.

Proceeding from the production state, the connecting assembly can assume a preassembly condition and a locking condition here by an axial relative movement between the holding pin and the receiving element, the connecting assembly being transferred from the preassembly condition to the locking condition by pressing the holding pin axially into the receiving element and back to the preassembly condition by rotating the holding pin relative to the receiving element about the longitudinal axis.

### BRIEF DESCRIPTION OF THE DRAWINGS

Further features and advantages of the invention will be apparent from the following description of a preferred embodiment given with reference to the drawings, in which:

FIG. 1 shows a perspective view of a connecting assembly according to the invention in a production state;

FIG. 2 shows a perspective view of the connecting assembly according to the invention from FIG. 1, in a preassembly condition;

FIG. 3 shows a perspective view of the connecting assembly according to the invention from FIG. 1, in a locking condition;

FIG. 4 shows a longitudinal section taken through the connecting assembly according to FIG. 1; and

FIG. 5 shows a further longitudinal section taken through the connecting assembly according to FIG. 1.

### DESCRIPTION OF EXEMPLARY EMBODIMENTS

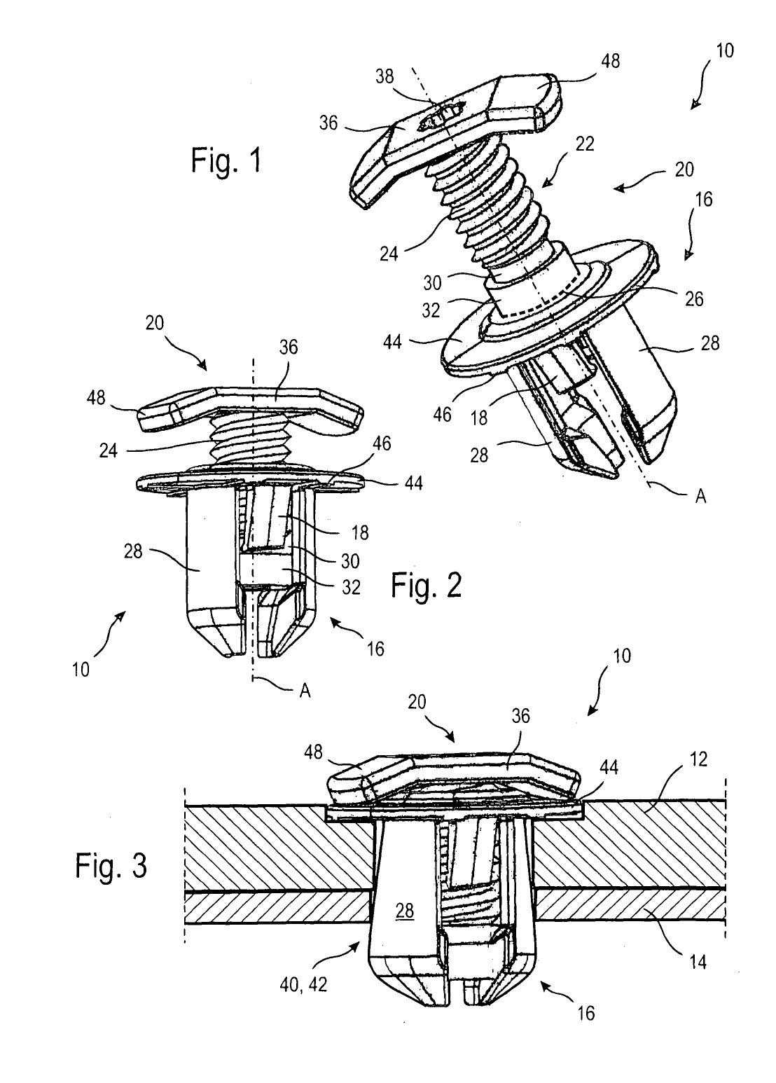

FIGS. 1 to 5 illustrate a connecting assembly 10 for releasably attaching a mount-on part 12 to a carrier 14, having a receiving element 16 which includes at least one elastically deformable latching element 18 that protrudes radially inwards, and a holding pin 20 which includes a shank 22 that is insertable into the receiving element 16 in the direction of a longitudinal axis A, the shank 22 having an external thread 24 formed thereon which in a locking condition of the connecting assembly 10 (cf. FIG. 3) establishes a form-fitting connection with the latching element 18.

FIG. 1 shows a production state of the connecting assembly 10, in which the receiving element 16 and the holding pin 20 are connected with each other in one piece. In the present exemplary embodiment, the receiving element 16 and the holding pin 20 are made as a one-piece injection molded part from a plastic material. The production of the connecting assembly 10 in one piece in an injection molding process has been found to be cost-effective and particularly simple in terms of production engineering. In the production state, a predetermined breaking point 26 is provided between the receiving element 16 and the holding pin 20, the predetermined breaking point 26 which is illustrated in a broken line in FIG. 1 being in the form of a circular predetermined breaking line.

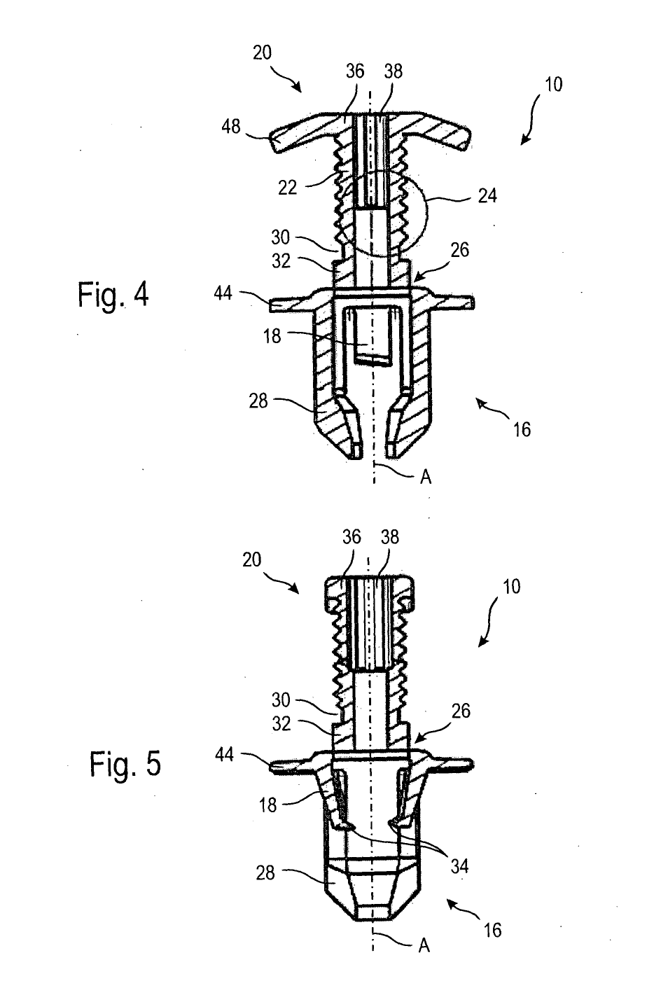

FIGS. 4 and 5 show longitudinal sections of the connecting assembly 10 in the production state, the section according to FIG. 4 being taken through holding means 28 molded integrally with the receiving element 16, and the section according to FIG. 5 being taken at right angles thereto through latching elements 18 molded integrally with the receiving element 16. The holding means 28 more particularly are axially extending, elongated feet that extend inwards at their free ends to form a cone.

It will be clear from the sections that in the production state, the holding pin 20 and the receiving element 16 are arranged substantially axially one on top of the other, with a small axial overlap being possibly present.

The holding pin 20 and the receiving element 16 are connected with each other merely by an annular contact area, this contact area having, for example, a perforation to form a predetermined breaking point 26.

Proceeding from the production state according to FIG. 1, the connecting assembly 10 may be caused, by an axial relative movement between the holding pin 20 and the receiving element 16, to assume at first a preassembly condition (FIG. 2) and then a locking condition (FIG. 3). When the holding pin 20 is acted upon axially towards the receiving element 16, the predetermined breaking point 26 will tear open when a predefined actuating force is reached, and the holding pin 20 is pushed into the receiving element 16. In the process, the shank 22 initially deforms the latching elements 18 radially outwards until the latching elements 18 engage into a recess 30 of the shank 22 when the preassembly condition (cf. FIG. 2) is reached.

FIGS. 1, 4 and 5 clearly show that in the present exemplary embodiment the recess 30 is a surrounding groove which is adjoined in the axial direction by the external thread 24, on the one hand, and by a radial projection 32, on the other hand.

Proceeding from the preassembly condition of the connecting assembly 10, the external thread 24 allows an axial relative movement towards the locking condition (FIG. 3), whereas the radial projection 32 blocks an axial relative movement towards the production state (FIG. 1). This may be achieved, for example, in that the projection 32 extends radially further outwards than the external thread 24. Alternatively or additionally, the release of the relative movement towards the locking condition and the blocking of the relative movement towards the production state may also be obtained by an appropriate geometry of the axial groove flanks and/or of the engagement sections 34 of the latching elements 18.

Since the connecting assembly 10 can not be moved from the preassembly condition back towards the production state, the holding pin 20 and the receiving element 20 are captively connected with each other. On the other hand, it is possible to transfer the connecting assembly 10 from the preassembly condition to the locking condition by pushing the holding pin 20 axially into the receiving element 16, and to transfer it back again to the preassembly condition by rotating the holding pin 20 in relation to the receiving element 16 about the longitudinal axis A. This allows a rapid attachment of the mount-on part 12 to the carrier 14, without a tool being normally required.

In addition, the attachment between the mount-on part 12 and the carrier 14 may be released again by simply turning the holding pin 20 relative to the receiving element 16. Here, engagement sections 34 of the latching elements 18 slide in the flight of the external thread 24 until the recess 30, that is, the surrounding groove of the shank 22, is reached. in this preassembly position, the connecting assembly 10 can be axially withdrawn from the mount-on part 12 and the carrier 14 without any major resistance, so that the attachment between the mount-on part 12 and the carrier 14 is released.

To be able to transfer the connecting assembly 10 from the locking condition to the preassembly condition especially rapidly, in the exemplary embodiment illustrated the external thread 24 is formed as a multiple thread with a large thread pitch.

In addition to the shank 22 that is insertable into the receiving element 16, the holding pin 20 comprises a head 36 which has an axial recess 38, with a cross-section of the recess 38 being formed in such a way that a suitable tool can engage in a form-fitting manner for turning the holding pin 20.

For attaching the mount-on part 12 to the carrier 14, the receiving element 16, more precisely the entire connecting assembly 10 in its production state or preassembly condition, is introduced both into an opening 40 of the mount-on part 12 and into an opening 42 of the carrier 14 until a stop 44 of the receiving element 16 rests against the rim of the opening of the mount-on part 12.

According to FIG. 1, the stop 44 is formed as a circular stop plate which includes form-fitting members in the form of radially extending ribs 46 on a side facing the mount-on part 12. These ribs 46 cooperate with complementary, radially extending grooves in the rim region of the opening 40 of the mount-on part 12 to constitute an anti-rotation protection means. In the locking condition of the connecting assembly 10, the anti-rotation protection means prevents the receiving element 16 from rotating relative to the mount-on part 12 about the longitudinal axis A. As a consequence, in the locking condition of the connecting assembly 10 (FIG. 3) the receiving element 16 is held on the mount-on part 12 so as to prevent relative rotation, and the holding pin 20 may be unscrewed from the receiving element 16 without any difficulty using a suitable tool, until the preassembly condition of the connecting assembly 10 is reached.

The holding means 28 of the receiving element 16 for fixing the receiving element 16 in place on the carrier 14 are elastic feet that are deflectable radially outwards by an axial displacement of the holding pin 20. In the section according to FIG. 4, the holding means 28 are in their unloaded initial condition since the connecting assembly 10 is shown in its production state. In the locking condition illustrated in FIG. 3, on the other hand, the holding means 28 are radially spread apart by the inserted shank 22 of the holding pin 20, so that the mount-on part 12 and the carrier 14 are clamped axially between the stop 44 and the holding means 28 that are deflected radially outwards.

In the exemplary embodiment of the connecting assembly 10 shown, the holding pin 20 includes a spring section 48 which in the locking condition acts axially upon the holding pin 20 relative to the receiving element 16 and thus ensures a defined latching engagement between the external thread 24 and the latching elements 18. The spring sections 48 are in the form of extensions on the head 36 of the holding pin 20 here so that the head 36 partially acts as the spring section 48.

In the locking condition of the connecting assembly 10 according to FIG. 3, the head 36 of the holding pin 20 rests against the receiving element 16, the spring sections 48 of the head 36 urging the connecting assembly 10 from the locking condition towards the preassembly condition.

In so doing, the axial force produced by the spring section 48 is sufficient to shift the holding pin from a presumed locking condition of the connecting assembly 10 relative to the receiving element 16 so far until the latching element 18 snaps into the next thread groove. What is referred to as a presumed locking condition here is an axial position of the holding pin 20 relative to the receiving element 16 in which the head 36 does in fact rest against the receiving element 16 (FIG. 3) but the latching element 18 has not latched in place in a thread groove but, in a radially expanded condition, engages a spiral thread projection between two thread grooves. The axial force generated by the spring section 48 is usually selected such that it is smaller than an axial holding force which is present when there is a defined latching engagement of the latching element 18 in a thread groove of the external thread 24.

1. A connecting assembly for releasably attaching a mount-on part (12) to a carrier (14), comprising
a receiving element (16) which includes at least one elastically deformable latching element (18) that protrudes inwards, and
a holding pin (20) which includes a shank (22) that is insertable into the receiving element (16) in the direction of a longitudinal axis (A),
the shank (22) having an external thread (24) formed thereon which in a locking condition of the connecting assembly (10) establishes a form-fitting connection with the latching element (18), and
the connecting assembly (10) having a production state in which the receiving element (16) and the holding pin (20) are connected with each other in one piece.

2. The connecting assembly according to claim 1, wherein the receiving element (16) and the holding pin (20) are produced as a one-piece injection molded part from a plastic material.

3. The connecting assembly according to claim 1, wherein the production state, a predetermined breaking point (26) is provided between the receiving element (16) and the holding pin (20).

4. A connecting assembly for releasably attaching a mount-on part (12) to a carrier (14), in particular according to claim 1, comprising
a receiving element (16) which includes at least one elastically deformable latching element (18) that protrudes inwards, and
a holding pin (20) which includes a shank (22) that is insertable into the receiving element (16) in the direction of a longitudinal axis (A),
the shank (22) having an external thread (24) formed thereon which in a locking condition of the connecting assembly (10) establishes a form-fitting connection with the latching element (18), and
one of the holding pin (20) and the receiving element (16) including a spring section (48) which in the locking condition acts axially upon the holding pin (20) in relation to the receiving element (16) to ensure a defined latching engagement between the external thread (24) and the latching element (18).

5. The connecting assembly according to claim 4, wherein the holding pin (20) comprises the shank (22) that is insertable into the receiving element (16), and a head (36), the head (36) being at least partially formed as spring section (48).

6. The connecting assembly according to claim 5, wherein the locking condition, the head (36) of the holding pin (20) rests against the receiving element (16).

7. The connecting assembly according to claim 1, wherein the production state of the connecting assembly (10), the holding pin (20) and the receiving element (16) assume an axial relative position in relation to each other that is different from that in the locking condition of the connecting assembly (10), the connecting assembly (10) further having a preassembly condition, in which the holding pin (20) and the receiving element (16) assume an axial relative position in relation to each other which is between the axial relative position in the production state and the axial relative position in the locking condition.

8. The connecting assembly according to claim 1, wherein the shank (22) of the holding pin (20) includes a recess (30) for engagement by the latching element (18) in a preassembly condition of the connecting assembly (10).

9. The connecting assembly according to claim 8, wherein the recess (30) is a surrounding groove which is adjoined in the axial direction by the external thread (24), on the one hand, and by a preferably radial projection (32), on the other hand.

10. The connecting assembly according to claim 9, wherein, proceeding from the preassembly condition, the external thread (24) allows an axial relative movement towards the locking condition and, proceeding from the preassembly condition, the projection (32) blocks an axial relative movement towards the production state.

11. The connecting assembly according to claim 1, wherein the receiving element (16) is insertable both into an opening (40) of the mount-on part (12) and into an opening (42) of the carrier (14), and further includes holding means (28) for securing the receiving element (16) in place on the carrier (14).

12. The connecting assembly according to claim 11, wherein the holding means (28) are elastic feet that are deflectable radially outwards by the axial displacement of the holding pin (20).

13. The connecting assembly according to claim 1, wherein the receiving element (16) has an anti-rotation protection means which, in the locking condition of the connecting assembly (10), prevents the receiving element (16) from rotating about the longitudinal axis (A) relative to the mount-on part (12) and/or to the carrier (14).

14. The connecting assembly according to claim 1, wherein the external thread (24) is a multiple thread.

15. A method for releasably attaching a mount-on part (12) to a carrier (14) by means of a connecting assembly (10) according to claim 1, the connecting assembly (10) having a production state, a preassembly condition, in which the connecting assembly (10) can be released from the mount-on part (12) and from the carrier (14), and a locking condition, in which the connecting assembly (10), the mount-on part (12) and the carrier (14) are attached to each other, the connecting assembly (10) being urged by a spring section (48) from the locking condition towards the preassembly condition.

16. The method for releasably attaching a mount-on part (12) to a carrier (14) by means of a connecting assembly (10) according to claim 1, the connecting assembly (10), proceeding from the production state, being adapted to assume a preassembly condition and a locking condition by an axial relative movement between the holding pin (20) and the receiving element (16), the connecting assembly (10) being transferred from the preassembly condition to the locking condition by pressing the holding pin (20) axially into the receiving element (16) and back to the preassembly condition by rotating the holding pin (20) relative to the receiving element (16) about the longitudinal axis (A).
